(19) United States
(12) Patent Application Publication
(10) Pub. No.: US 2002/0138349 A1
(43) Pub. Date: Sep. 26, 2002

(54) Direct marketing system

(76) Inventor: W. Stephen Platt, Sanibel, FL (US)

Correspondence Address: WELSH & FLAXMAN LLC, 2341 JEFFERSON DAVIS HIGHWAY, SUITE 112, ARLINGTON, VA, 22202, US

(21) Appl. No.: 10/101,502

(22) Filed: Mar. 20, 2002

Related U.S. Application Data
(60) Provisional application No. 60/277,956, filed on Mar. 23, 2001.

(51) Int. Cl. G06F 17/60

(52) U.S. Cl. 705/14

(57) ABSTRACT

An interested prospect identification and control process is achieved by providing a primary offer to a group of prospects, identifying the prospective buyers as customers and non-responding prospects based upon the primary offer, providing a secondary offer to the prospects, identifying those non-responding prospects as responding prospects when they respond to the secondary offer and applying gathered information in enhancing future offerings.

### CROSS REFERENCE TO RELATED APPLICATIONS

The present application is based upon U.S. Provisional Patent Application Serial No. 60/277,956, entitled “DIRECT MARKETING SYSTEM”, filed Mar. 23, 2001, which is currently pending.

### BACKGROUND OF THE INVENTION

1. Field of the Invention

The invention relates to a direct marking system. More particularly, the invention relates to a direct marketing system enhancing prospect contact by providing secondary offers based upon activity/nonactivity.

2. Description of the Prior Art

In any type of direct marketing activity, including traditional direct mail, catalogs, television shopping, as well as e-commerce, the acquisition of new customers, particularly those that will continue purchasing in the future, is very important. As a general rule, prospective customers, or prospects (i.e., individuals who have not made a previous purchase from an organization) are less responsive to offers than established customers (i.e., those who have made one or more purchase from an organization).

The direct marketing industry has, overtime, developed very sophisticated capabilities, both internal to an organization, and throughout the industry in general, to identify and facilitate the transfer (rental or exchange) of prospective new buyers. In addition, a number of informational overlays, statistical modeling, and information combination capabilities have been and are continually being developed. While some organizations have a policy of not renting their customer lists, other organizations provide, in almost “real time”, the name and address, summary purchase history and other demographics of recent buyer “hot-lines” to other similar organizations on an ongoing basis.

The rules/traditions, and, therefore, the list rental agreements, within the direct marketing industry provide a concept of ownership of customer lists and the renting or exchange of those lists. The prospective buyers maintained on the rented list may be solicited at stated and agreed upon offer amounts, as well as with regard to agreed upon products and/or services. Any prospective buyer contacted via a rented list and responding to the renting organization's offer becomes part of that organization's customer list. The new customer may then be promoted unconditionally and as often as desired. In addition, that customer's information (name, address and other information, such as, size of order, date, and method of payment) can then be rented or exchanged to other organizations to use in their promotions.

While every attempt is made to target the best prospective buyers, for example, in terms of long term value of responders, actual response and order amount/profitability, the need to generate a significant number of new customers dictates prospecting to larger numbers of prospects, many of which offer lower probabilities of success. Rates vary upon a number of factors, and response rates to prospects can be as low as 0.5 percent and up to as high as 4 or 5 percent depending on the offer. Many organizations operate successfully with response rates of 1 to 1.5 percent. The obvious result is that a large number of prospects (95 to 99.5 per cent) do not respond to a particular offer.

After a promotion, prospects, and also customers, fall into one of two groups: those who responded and those who did not respond. Current industry techniques classify responders in a variety of classifications relating to the order, including, product/category, method of ordering, method of payment, amount of the order, etc. However non-respondents, since there is no response or order, do not have that same basis for classification.

Some of the more advanced organizations keep data files of mailings to prospective buyers. Because of the constant exchange of information and customer names/addresses, what actually occurs is that many of prospects are continually re-rented, both from the same as well as other sources, and re-mailed over a period of time.

Non-respondents do not respond for a variety of reasons. Among other reasons, non-respondents commonly fail to respond to an offer based upon non-receipt of the offer due to delivery issues, errors in addressing/mailing, people moving, etc. If, however, an offer is received, only a portion of it is commonly read before the recipient discards the offer without reading the entire proposal.

In order to encourage prospective buyers to read and respond to an offer once it is received, the industry has, and is, continually devising marketing techniques to encourage prospects (and customers) to respond to an offer. These techniques vary widely. Some of the most successful and, therefore, frequently utilized techniques include: offering free/reduced shipping and handling; offering premiums/free gifts; providing a sweepstakes entry; offering discounts; “threatening” to stop mailing in the future; offering frequent flyer air mileage; and receiving extended credit and or extended credit with no finance charge.

As those skilled in the industry certainly appreciate, within the read-but-non-respondent category there are various imaginable segments. The non-responders are not homogenous; there are those that almost responded, those that will more likely respond to one of several future offers, as well as those that have no intention or ability to ever respond.

The present invention attempts to tap into the group of read-but-not-respondent category by identifying the large non-segmented, non-responding prospective buyers portion of those segments that are more likely and less likely to respond to future offers. The present invention then facilitates the mailing of distinctly different future offers and frequency of offers, if any, to the different identified segments.

### SUMMARY OF THE INVENTION

It is, therefore, an object of the present invention to provide an interested prospect identification and control process. The process is achieved by providing a primary offer to a group of prospects, identifying the prospective buyers as customers and non-responding prospects based upon the primary offer, providing a secondary offer to the prospects, identifying those nonresponding prospects as responding prospects when they respond to the secondary offer and applying gathered information in enhancing future offerings.

It is also an object of the present invention to provide an interested prospect identification and control process wherein the primary offer and the secondary offer are simultaneously provided to prospects.

It is another object of the present invention to provide an interested prospect identification and control process wherein the responding prospects are further classified as interested prospects and very interested prospects.

It is a further object of the present invention to provide an interested prospect identification and control process wherein an upsell offer is made to prospects responding to the secondary offer and those prospects responding to the upsell offer are classified as very interested prospects.

It is yet another object of the present invention to provide an interested prospect identification and control process wherein the responding prospects are further classified as interested prospects, very interested prospects and not interested prospects.

It is still another object of the present invention to provide an interested prospect identification and control process wherein the secondary offer includes a not interested prospect element and those prospects responding to the not interested prospect element are classified as very interested prospects.

It is yet a further object of the present invention to provide an interested prospect identification and control process including the step of providing not interested prospects with an opportunity to remove their name from future offers.

It is also an object of the present invention to provide an interested prospect identification and control process including appending a uniquely numbered offer control number to each secondary offer.

It is also an object of the present invention to provide an interested prospect identification and control process wherein the secondary offer is chosen from the group consisting of offers to receive future offers; enrollment in a free club; receipt of a discount/benefit on a future order; receipt of discounts for future needed items for which there is not an immediate need; a free premium; a free trial; a sweepstakes type of offer, discounted shipping and handling; airline miles; free software; discounts on specific products; informational products; avoidance of an expiration date and combinations of one or more of the above.

It is another object of the present invention to provide a system for identifying interested prospects in a directing marketing process. The system includes an offer database in which offers being utilized by an organization are stored. The offers include primary offers directed to a promotion containing products or services to be offered and secondary offers directed to eliciting a response from those prospects not wishing to respond to the primary offer. The system further includes a uniquely numbered offer control database in which control numbers associated with each offer are stored, an interested prospects database in which data relating to prospects who have responded to the secondary offer are stored and means for processing information relating to the primary and secondary offers.

It is a further object of the present invention to provide a system for identifying interested prospects in a directing marketing process including a very interested prospects database in which data relating to those prospects who respond to the secondary offer and an upsell is stored.

It is also another object of the present invention to provide a system for identifying interested prospects in a directing marketing process including a not interested prospects database in which data relating to those prospects who respond to a not interested prospects element of the secondary offer is stored.

It is still another object of the present invention to provide a system for identifying interested prospects in a directing marketing process wherein the secondary offer is chosen from the group consisting of offers to receive future offers; enrollment in a free club; receipt of a discount/benefit on a future order; receipt of discounts for future needed items for which there is not an immediate need; a free premium; a free trial; a sweepstakes type of offer, discounted shipping and handling; airline miles; free software; discounts on specific products; informational products; avoidance of an expiration date and combinations of one or more of the above.

It is also an object of the present invention to provide a system for identifying interested prospects in a directing marketing process including an additional data database.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a flow chart of the present process.

FIG. 2 is a flow chart for a prospect responding to a not interested prospect offer.

FIG. 3 is a flow chart for a prospect responding to an interested prospect offer.

FIG. 3a is a continuation of the flow chart shown in FIG. 3.

FIG. 4 is a flow chart for prospect processing, UNOC number assignment and database creation.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limited, but merely as the basis for the claims and as a basis for teaching one skilled in the art how to make and/or use the invention.

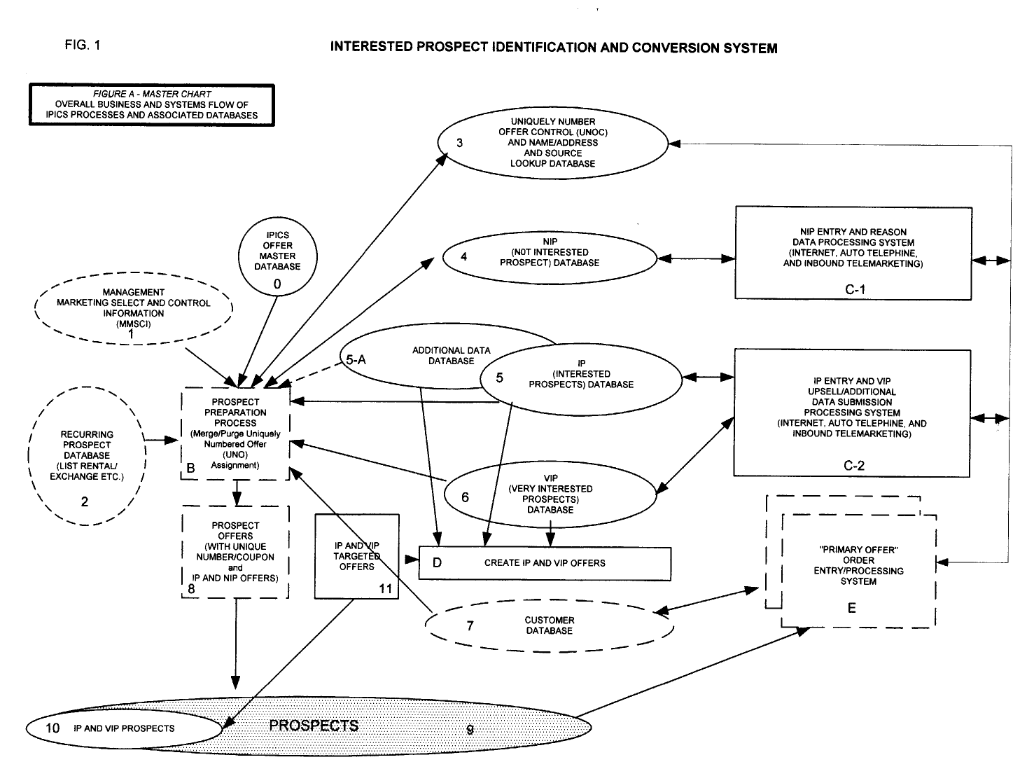

With reference to FIG. 1, a flow chart of the present Interested Prospect Identification and Control System (IPICS) is presented. The IPICS is a business system that improves the overall profitability of an organization by making more effective its direct marketing (traditional and ecommerce) acquisition of new customers. The IPICS is based on creating a secondary, or interested prospect, offer, which is marketed along with existing “primary” offers. The interested prospect offer is designed to encourage a prospect who is not responding to the primary offer to take an action at no cost, with minimum effort, and with a future incentive. The interested prospect offer targets non-respondents, typically 98+ percent of prospects solicited. A glossary of relevant terms used throughout the present specification is appended at the end of the following disclosure.

In accordance with a preferred embodiment of the present invention, an interested prospect identification and control process is provided. The process is achieved by initiating a primary offer to a group of prospective buyers, identifying the prospective buyers as customers and nonresponding prospects based upon the primary offer, providing a secondary offer to the nonresponding prospects, identifying non-responding prospects as interested prospects and not interested prospects, applying gathered information in enhancing future offerings. The information gathered as a result of the present process is processed, stored in various databases and applied to improve future direct marketing campaigns.

The secondary, interested prospect offer is sent with the primary offer in accordance with a preferred embodiment of the present invention. However, those skilled in the art will appreciate that the various offers may be sent at different times if it is determined that the use of different contact times might be advantageous.

Briefly, and as will be discussed in greater detail below, the IPICS process is accomplished by a combination of:

1. Establishing a secondary, no risk easy-to-utilize, offer containing one or more benefits that the more interested “non-responding-prospect-to-the-primary-offer” will find sufficiently attractive to warrant a cost free and nearly effortless response.

2. Applying information systems coding and “Uniquely Numbered Offer Code” (UN0C) identifying individual prospects.

3. Providing several easy to respond to and convenient to process capabilities (an Internet, automated telephone based entry system, or scannable mail in cards) to facilitate acceptance of the secondary offer.

4. Forwarding subsequent offers to the original respondents of IPICS process featuring special offers and promotions associated with the original UNOC number, and treating that number as an individualized “electronic coupon”.

As will be better appreciated based upon the following disclosure, the IPICS utilizes a series of linked components to facilitate implementation of the present process. Specifically, the IPICS includes an offer master database 0. The master database 0 is controlled by the organizations marketing management which maintains the data elements required to process an IPICS response (interested prospect, very interested prospect, upsell and/or additional data). The master database 0 further processes descriptive information required to computer inserted information, web pages and valid offer dates/conditions of each IPICS offer.

The system is further provided with a management marketing selection and control information database (MMSCI) 1. The MMSCI database 1 is prepared by the organization's marketing management to control the selection of individual prospect records, including the assignment of offers from the IPICS offers master database 0 to each prospect segment (i.e., interested prospects, very interested prospects, not interested prospects and customers) and selection parameters to determine the selection or suppression of not interest prospect matching prospects.

A recurring prospect database 2 is also maintained in accordance with the present invention. The recurring prospect database 2 is the source of new prospects. A database, or databases, of this type currently exist and are commonly employed by those using conventional direct marketing campaigns. With this in mind, the recurring prospect database 2 primarily contains the names and addresses, possibly telephone numbers, of prospects that have been rented or exchanged for the purpose of offer solicitation.

The present system also includes a uniquely numbered offer control database 3 which facilitates processing of respondents to the interest prospect, not interest prospect and very interest prospect offers. The uniquely numbered offer control database 3 may also be utilized as a controlling database for facilitating traditional primary product/service order processing and offers. It contains, at a minimum, the prospect's name and address, source code and the UNOC number. As individuals respond to IPIC offers (interested prospect offers, very interest prospect offers and not interest prospect offers) or primary offers the uniquely numbered offer control database 3 is updated. Furthermore, once an individual has made such an IPICS response, a new UNOC number is assigned for each interest prospect, very interested prospect and not interest prospect promotion. These newly assigned individual UNOC data records are used to track the promotion and also contain the original UNOC number as a reference. The UNOC records remain open until there is virally no chance of response (which will generally be approximately one year from the creation of the data record).

The system also includes a not interested prospects database 4. The not interested prospect database 4 contains the names and addresses, and the selection information, of those respondents to not interested prospect offers. The not interested prospect database 4 may also contain additional data requested and submitted by those not interested prospects responding to a specific query. As individual data records are created for each respondent to a not interested prospect offer, the UNOC database 3 is updated to indicate such a response. Not interested prospects selected for and responding to prospect offers are removed from this database as they are added to the customer database 7.

An interested prospect database 5 is further maintained in accordance with the present invention. The interested prospect database 5 contains the names and addresses, and the selection information, of those respondents to an interested prospect offer. The interested prospect database may also contain additional data requested and submitted by those interested prospects responding to a query. As individual data records are created for each interested prospect respondent, the UNOC database 3 is updated to indicate such a response. Interested prospects responding to an interested prospect offer are removed from the interested prospect database as they make a purchase and are added to the customer database 7.

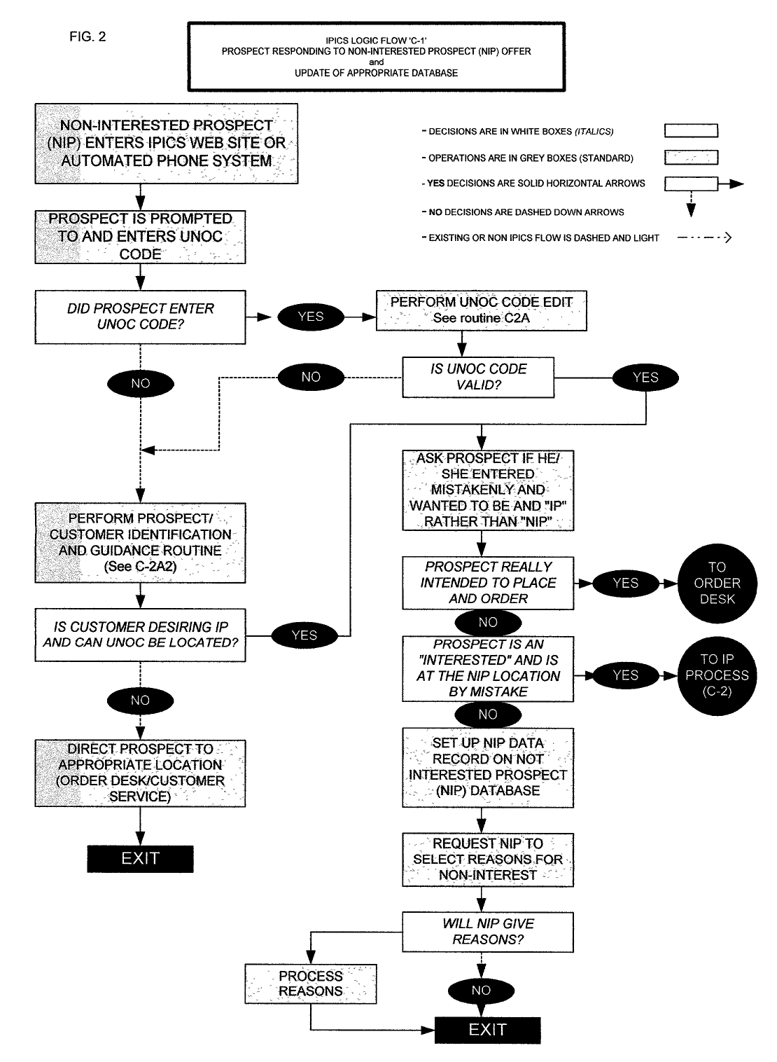

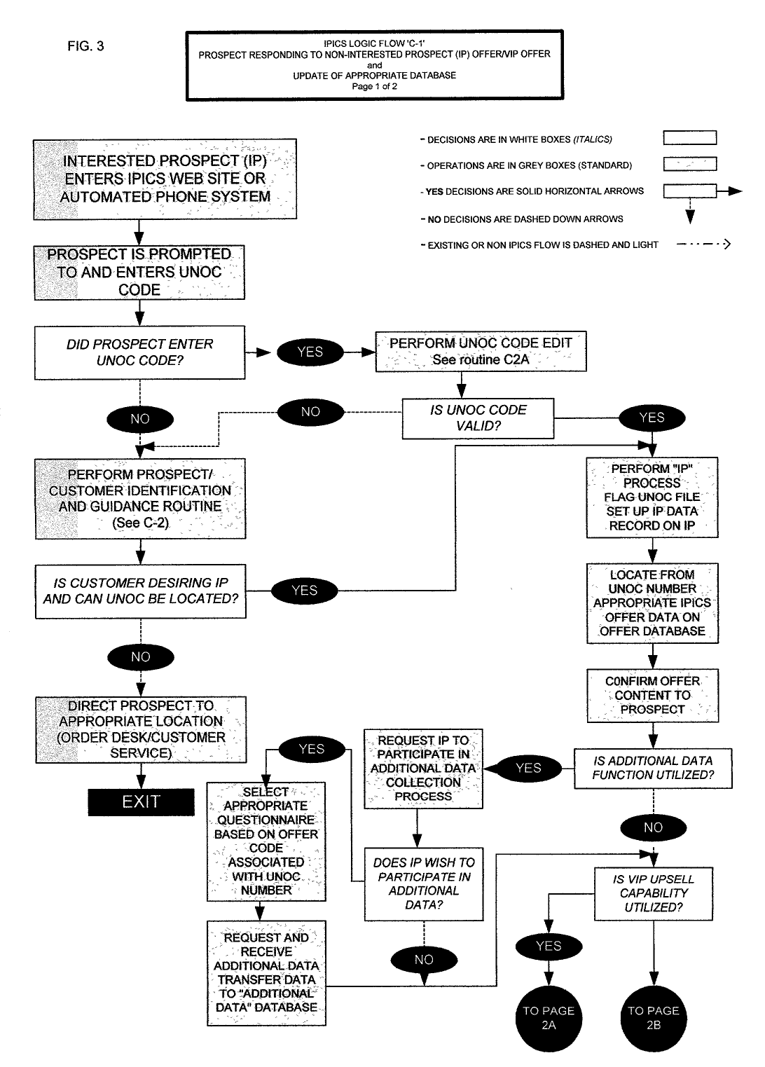

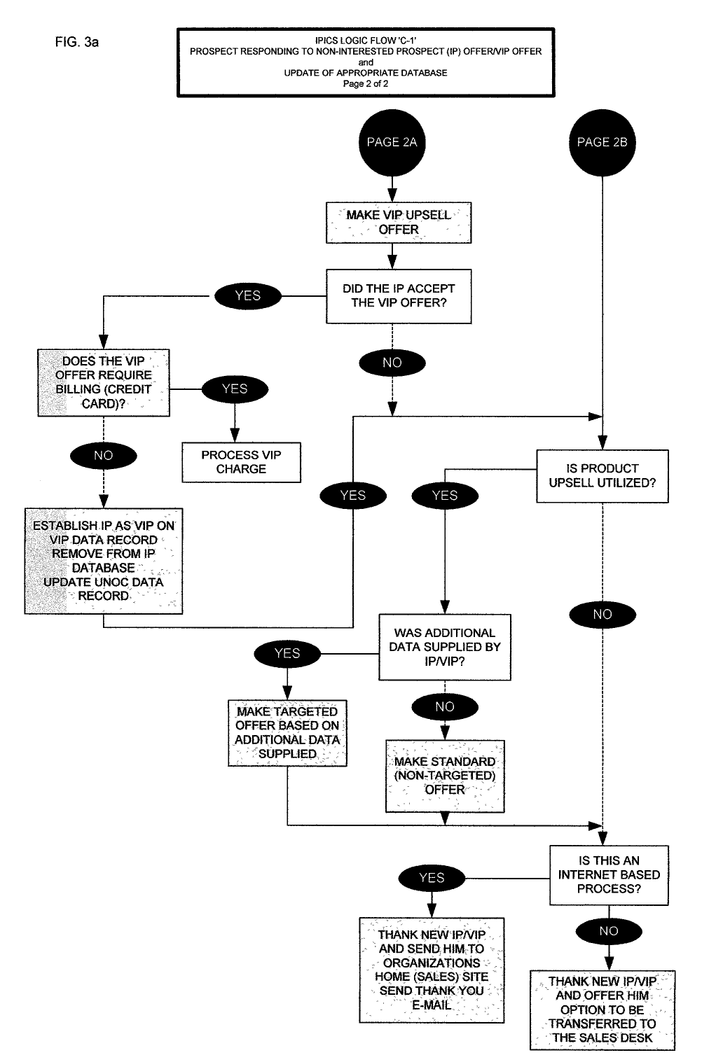

The system further includes an additional data database 5-A. The additional data database contains the coded response to a request for information in the interested prospect, very interested prospect and not interested prospect processes discussed below with reference to FIGS. 2, 3, and 3a. The additional data database 5-A is keyed on the UNOC number and is free form, thus permitting each organization to structure information as it pertains to that organization and its products and customers.

A very interested prospect database 6 is also maintained by the present system. The very interested prospect database 6 contains the names and addresses, and the selection information of those respondents to the very interested prospect upsell offers discussed below in greater detail. Briefly, these upsell offers are made immediately following the interested prospect processing. As individual data records are created for each very interested prospect respondent, the UNOC database 3 is updated to indicate such a response. Very interested prospects responding to a very interested prospect offer are removed from this database as they are added to the customer database 7. It should be noted that because of the acceptance of a very interested prospect offer usually involves a financial transaction, it may advantageous to process very interested prospect updates in a similar process as that of a primary response (i.e., order or enrollment). This may mean that positive very interested prospect responses are best additionally processed through the organization's standard order processing capability. However, if the present process is utilized, care should be taken to marketing and reporting (historical comparisons, response rate, average order size, etc.) this information separately.

As referenced above, the present system will also include a customer database 7 including all of the organization's customers. Most direct marketing companies currently maintain such databases.

The system also includes a UNOC match code cross-reference database (index) (not shown) as will be discussed below in greater detail. IPICS utilizes the UNOC key to control its databases. Newly acquired prospects contain names and addresses, from which match codes are commonly built. This processing includes elimination of duplicate prospect records, matching prospects to customer files and other uses. Because the updated notation of repeated prospect activity could be significant to previous interested prospects and very interested prospects, selection criteria, as well as the need to eliminate or selectively target subsequent offers to previous not interested prospect respondents, the UNOC-Match Code Index database is created for all UNOC creations.

Taken from the starting point of a traditional direct marketing campaign, an organization wishing to make a primary offer to a group of prospective buyers must first obtain a list of the prospective buyers. As mentioned above, these lists maybe rented from other organizations or developed internally using well known gathering techniques commonly applied within the industry. Once the appropriate list is developed, the organization then proceeds with the development of their primary offer.

At the time the primary offer is presented to the prospective buyers, 95%, or greater, of the prospective buyers will not respond to the primary offer. The present invention deviates from prior art techniques by supplementing the primary offer with the creation and distribution a secondary, or interested prospect, offer D.

One of the key components of the IPICS process is the creation of an interested prospect offer D not designed to produce an immediate sale, enrollment, or subscription. Rather, the interested prospect offer is designed to prompt and facilitate the prospect to identify his/her interest by responding to the beneficial, risk and cost free offer. Because the nature of both the primary product/service and the prospects vary, skill and creativeness is required to create an effective interested prospect offer in accordance with the IPICS process. Like any other direct marketing offer, alternatives must be tested and measured.

The interested prospect offer in accordance with the IPICS process is presented as a secondary offer to the primary offer, a traditional expenditure (purchase or enrollment). As opposed to the typical primary offer, which usually involves a purchase or commitment from the prospect, the interested prospect offer, which varies based on the utilizing organization, is risk and cost free. In addition, the interested prospect offer will usually offer the prospect a benefit. Because this offer will be of interest to those otherwise non-responding prospects that have the greatest interest and tendency to respond to future offers, those that respond to this secondary offer become part of a new and growing “Interested Prospect” (IP) segment of that previous non-distinguished 98+ percent of prospects. Available data regarding the interested prospect segment is saved in the interested prospect database 5.

The interested prospect offer is designed, to the extent possible, to have little or no negative impact on the primary offer. The interested prospect, or secondary, offer may take several forms, all of which require an immediate response. Examples of the interested prospect offer include the following:

1. Merely receive future offers, or a deluxe or master offering.

2. Enroll in a free “club”

3. Receive a discount/benefit on a future order, which will be contained in those offers.

4. Receive discounts for future needed items for which there is not an immediate need, including, but not limited to, appliances (water heaters, refrigerators, air conditioners), automotive accessories (tires, batteries, brakes, tune-ups), and major purchases (autos, airline travel, cruises) or other such potential future needed items (eyeglasses, jewelry) (While these would apply to future purchases, they may also have an expiration date).

5. A free premium or trial

6. A sweepstakes type of offer, with a series of prizes

7. Discounted or free shipping and handling

8. Airline miles

9. Free software

10. Discounts on specific products

11. Informational products (newsletters, tips) via mail or e-mail.

12. Avoid an expiration date.

13. A combination of one or more of the above

The benefits listed above are merely exemplary of those which maybe used in accordance with the present invention. With this in mind, those skilled in the art will appreciate the various interested prospect offers which maybe proposed within the spirit of the present invention. Whatever benefits are contained in the secondary, interested prospect offer should also apply to the primary offer. The secondary offer is designed so as not to deter from the primary offer. The secondary offer must be painless, risk free, easy to understand, and desirable to the prospect. All information must be confidential. The success of the IPICS process varies greatly with the nature and presentation of the, secondary, interested prospect offer.

The true nature and value of the interested prospects must be measured in each situation, but it is very probable that the future responsiveness (and value) of the those interested prospects responding to an interested prospect offer will lie between that of a respondent and that of a non-respondent. Assuming the secondary offer is attractive to the non-responding prospect, and he or she contacts the organization as desired in accordance with the present invention, the prospect will become an interested prospect. The identified interested prospects will then be marketed frequently and rapidly, with targeted offers, designed to convert them to more traditional customers.

The present invention skillfully provides for the tracking of prospects and the associated interested prospect offers by associating an identification number with each of the interested prospect offers. Specifically, included in some form with the response is a Unique Numbered Offer Control (UNOC) number assigned, and incorporated with the interested prospect offer, during the creation of the promotion. The UNOC number represents a unique combination of: prospect information (name, address, source, other known classification data); offer information (media, date, products, special promotion); and, because of the uniqueness of the UNOC number, potentially any specific individual related (offer, personalization data) conditions. The UNOC number is prominently displayed within the creative format of the IPICS promotion/offer.

When an otherwise non-responding prospect responds to the interested prospect offer, he/she has segmented himself from the vast number of non-respondents as an interested prospect, and is then offered further promotions from the organization on a targeted and frequent basis. These offers are designed to convert the demonstrated interested prospect into a primary responder, i.e., one who regularly purchases products or services that identify that prospect as having an interest in receiving additional promotions from the organization. These subsequent offers will extensively make use of the UNOC number as an individualized “electronic coupon”, applicable to special offers.

The UNOC number contains a check digit to insure accuracy and is stored in a data base 3 along with other information, including, the prospects name and address, the nature of the offer and or a code which relates to the offer, a notation of the acceptance and the date. As the individual prospects respond, a separate positive prospect database 5 of interested prospects is created. This database 5, which represents individuals that fall between prospects and customers, can be targeted with unique conversion offers.

As mentioned above, implementation of the IPICS process is facilitated by assigning all (prospect) offerings a UNOC number. This number, along with the customer's name and address is saved in an accessible uniquely numbered offer control database 3. The numbering scheme utilized in accordance with the present invention will be similar to numbering schemes currently in use, on a limited basis, by direct marketing organizations to reduce order entry time and promote accurate recording of the order's name, address, and applicable advertising source, although other numbering schemes may be applied without departing from the spirit of the present invention.

The UNOC number is not only created (as is common in prior art systems mentioned above), but the UNOC number is also utilized as a coupon or offer number applied to store special offer conditions within the database 3. The responding prospect or customer utilizes this same unique number either by going to a special web-site of the organization or dialing a toll free automated telephone system, and, in either case, when prompted, enters his UNOC (coupon) number to accept the unique offer.

Once the secondary offer in accordance with the present invention has elicited a response from the previously non-responsive prospect, the prospect becomes a respondent. As those skilled in the industry will certainly appreciate, a response of any kind is generally the most significant predictor of future response. Therefore, the individual interested prospect, who has now made an all-important “response”, (albeit to not the primary (sale) offer, but the “secondary” IPICS offer) is now identified (segmented) and added to a segment (list) of similar respondents. This new segment, separate and in addition to the original “primary response” group (orders) is now owned and maintained by the organization. Without the IPICS process this prospect would certainly have remained only part of the overall non-distinguished non respondent category.

As a result of this positive action, the organization generates a list of interested prospects which are stored in the interested prospects database 5. These interested prospects will likely be more responsive then the balance of non-respondents with which these prospects where previously grouped. By repeating over time prospect offerings in accordance with the present invention, additional secondary, interested prospect respondents will be identified. This identified segment is then offered more frequent, possibly different targeted offers than new and recurring prospects.

The “primary” response (orders) to these offers and the “lifetime value” resulting from future (customer) business of these new additional customers is what generates a significant portion of the present invention's benefit. Since the new prospects contained in this segment are being promoted in a targeted and more aggressive manner, these prospects are eliminated from future (standard) prospect offers. This results in advertising savings.

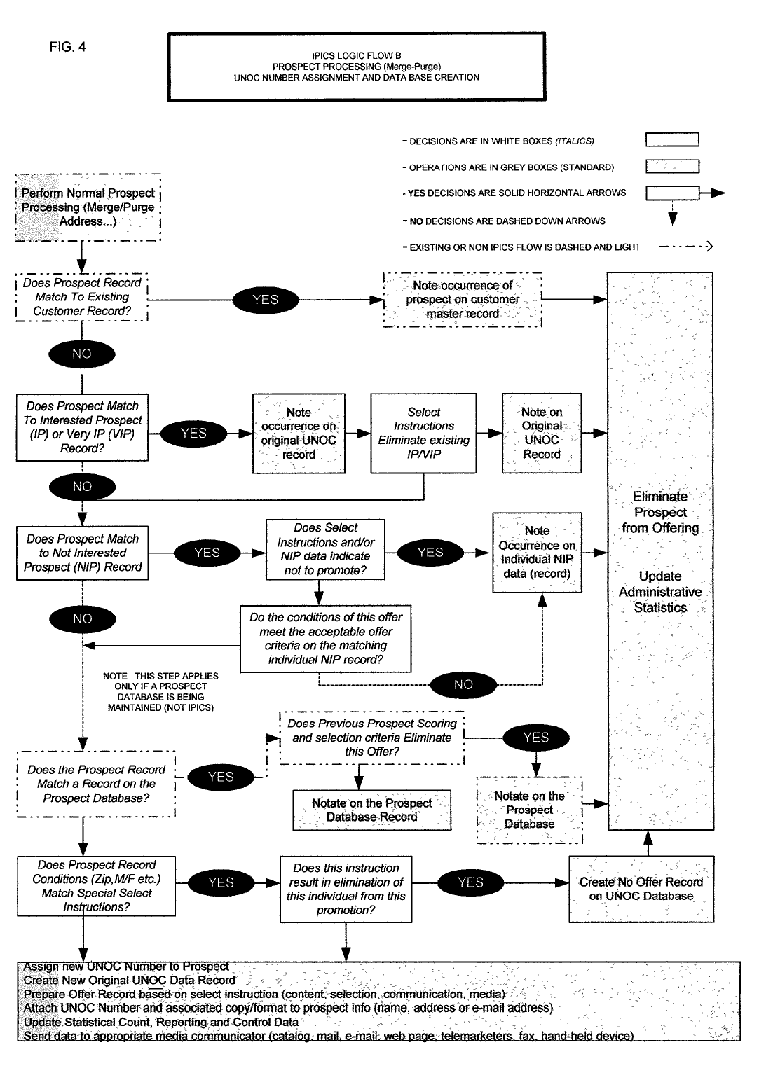

The cumulative impact of the IPICS process over time, creating a growing interested prospects segment, is extremely profitable when that segment is both targeted with special and frequent offers, as well as utilized to eliminate matching new prospects from future prospect offers (see subroutine B shown in FIG. 4). Through the application of the present invention, the otherwise non-responding (to the primary offer) prospect identifies his/herself, by responding to an interested prospect offer. The response is made either via an automated telephone response, Internet based system, or a scannable postage prepaid mail-in card.

In addition to the primary interested prospect function, the IPICS business process optionally provides for the gathering of prospect supplied “additional data” (which is stored in the additional data database 5-A and the capability for a “Not Interested Prospect” (IP) to reduce or eliminate himself from future offerings (see subroutine (C-1). The additional data capability further identifies and segments the new interested prospect and provides not only the opportunity to target future offers and upsells, but information that can be utilized to predict which of the individual interested prospects have the highest probability of conversion and repeated activity (i.e., “lifetime value”).

The not interested prospect process provides a mechanism for those prospects who have no interest in receiving future offers to identify themselves. After verifying, through testing, the reduced response rate of these individuals, the accumulating not interest prospect segment can be utilized to eliminate those individuals from future prospect offerings.

The IPICS process additionally includes an optional very interested prospect upsell capability. In accordance with this feature an upgraded offer is presented to the newly enrolled interested prospect, usually for a small fee 10, 11. After completing the IP/VIP enrollment process, the individual can be made a special product/service offer, targeted if the additional data capability is utilized. In all cases, however, the IP/VIP is offered the option of being transferred to a sales web-site or order desk

The availability of the information associated with the IPICS process is further incorporated into other processes to make them also more effective. While the IPICS business process is totally new and innovative, it can be integrated with other, frequent and infrequently used, business processes.

In particular, UNOC control number utilization can be shared with some of these other uses. Most notable of these is the facilitating of cost effective and more accurate entering of traditional orders, as well as possible use of the UNOC number as unique information based “electronic coupon”.

The IPICS business process is designed to identify those individuals that have higher interest, and are more likely to respond than the majority of non-respondents, from the extremely large majority (well over ninety-five percent) of non-respondents to the (primary offer of prospect solicitations/mailings. This allows these individuals to be targeted with different and more frequent offers than future prospects.

Additionally, the IPICS process offers add-on option upgrade actions and processes and information gathering techniques to further qualify the secondary prospect respondents following their initial process.

In general, the IPICS business process creates an attractive no (or very low) cost, no obligation, and desired additional (to the primary) offer, or interested party offer, to which an otherwise non-responding prospect can easily respond. That is, the non-responding prospect simply and conveniently responds by visiting a web-site, dialing an automated response 800 number, or contacting the organization's call center.

While a response to an interested prospect offer does not result in an order based upon the nature of the IPICS process, the initiation of a response is nevertheless a positive response by the interested prospect. It indicates a positive action on the part of the customer, and the organization is able to create a small additional segment of interested prospects from that vast number of non-respondents generated by the original offer.

It is contemplated that the variations may be applied to the IPICS process. For example, the interested prospect may be permitted to upscale the offer, thus upscaling the prospect to a very interest prospect 10, 11. Specifically, by making the interest prospect offer absolutely painless, there is the opportunity, after the prospect has responded, to offer him/her the chance to step up, or upscale. For example, if a response entitles the prospect to 5% off, a $5 fee might be subsequently offered to entitle him to a greater of $10 or 10% offer. This would be presented as an option only after the first “painless” interested prospect offering was made and completed. This process would occur through automated telephone “upsell”, inbound call center operator, or web-site processing.

Ultimately, this creates an additional third category of prospects, i.e., very interested prospects which are saved in the very interested prospect database 6. The use of a very interest prospect offer is discouraged until the IPICS capability has been utilized and measured. This will also discourage organizations from creating an impression of a “bait and switch” offer or otherwise distorting the IPICS interested prospect process.

Following the processing of an IPICS response, there is an opportunity to make a specific high value offer to finally attempt to convert an IP/VIP respondent to a true purchaser (primary respondent). If the IP/VIP has participated in the additional data process, there is an opportunity to create targeted offers 11 based on the information supplied

In addition, the IPICS system may be enhanced by providing the interested prospect with additional information. After registering for the interested prospect and/or very interest prospect offer, the respondent may be asked to provide information about product category interests, demographics, size or product choice interests. This creates an additional level of interest and information that can be utilized in developing targeted offers and, additionally as a promotional-scoring element.

It is further contemplated that responding prospect may be subsequently categorized as not interested prospects (NIP) 4. In accordance with this feature, prospects are permitted to remove themselves from further solicitation. This database is utilized as a screen and a promotional scoring element to alter and perhaps eliminate future promotions to those prospects; thus reducing low/no response advertising expense. This is an additional, fourth, category of customers.

One of the key benefits of the IPICS business process is the identification of interested prospects and very interested prospects, and the subsequent results of promotions to these individuals. These subsequent promotions may include:

1. Are from a variety of media direct mail/catalogs, Internet (e-mail), outbound telemarketing, and fax. Through use of the Additional Data feature, interested prospects and VIP's can customize the format of their promotional communication.

2. Can be customized and different from either customer or prospect promotions.

3. Because of the demonstrated initial responsiveness and probable higher interest and future responsiveness of the interested prospects/very interested prospects, these individuals can and will be promoted more frequently than prospects.

4. Through personalization, promotions can remind the interested prospects/very interested prospects of the benefits, if any, that he is entitled to as a result of his initial acceptance of the interested prospect or very interest prospect offer. If these offers had expiration dates the urgency of the offer can be highlighted.

The IPICS process offers a wide range of benefits. For example, in addition to having the traditional small respondents and the large non-respondents, there is now up to three additional segments that, because of the actions they have taken, will be more responsive to future offers. The interested prospects will have higher, and the very interested prospects still even higher, response to future offerings than non-respondents. This identification of segments within the original non-respondent group permits special offers and additional offers. With repeated prospect offerings, this list will grow into a substantial and productive source of sales and new customers.

Not interested prospects will, based on test results for each organization utilizing the IPICS business process have varying results, be less responsive, consequently justifying the elimination of these prospects from future offers. The negative responders form the bases of an additional list segment that can be utilized to eliminate these individuals from future prospecting efforts, thus reducing costs. Because this list will generally be less responsive then the balance of prospects, the balance of prospect list responses will be higher.

Similarly, because of their actions in responding to the interested prospect offer in accordance with the present invention, and their addition to the company's interest prospect and very interested prospect databases 5, 6, the organization can eliminate these individuals from prospect acquisition; thereby, reducing expenses.

The prospects will have a better image of the organization which, by the nature of this program, appears to be making a real effort to identify both the more and less interested prospects. While the results would be beneficial for a single offering, the cumulative results are even more significant. Over a number of promotional efforts and several years the numbers of Interested Prospects will grow. The benefits accrued from the higher than normal response to the growing interested prospects lists and the “lifetime value” of those additional new (primary responders) customers resulting from the higher response to the interested prospect offers is substantial.

The data generated by the responses of interest prospect and very interested prospects, as well as not interest prospects, is processed for further use in a controlled manner (see subroutines C-1 and C-2). For example, and with reference to FIG. 2, a flow chart of the processing involved when a not interested prospect responds to an offer is shown. First, the not interested prospect enters a web site, or automated phone system, maintained by the organization and to which the not interested prospect is directed by the offer. The prospect is then prompted to and enters the UNOC code appended to the offer to which he/she is responding.

If the prospect enters the appended UNOC code, the code is verified to determine whether it is valid. If valid, the not interest prospect is informed that he/she has selected the “Not Interested” response and is given an opportunity to switch to the interested prospect processing (which is discussed below). In the event the responding prospect has inadvertently entered the not interested prospect process, he/she is easily switched to the interest prospect process.

After the UNOC number is verified, and the prospect confirms that he/she wishes to be a not interested prospect, the UNOC database 3 is accessed to ascertain the prospect's name, address, source code and any other special information (special offer) associated with that UNOC number. The UNOC database 3 is updated to indicate the occurrence of a response, including, the date and time of the response, method of response and other data relating to the response (name and address). The new not interested prospect information is set up on the not interested prospect database 4 including the not interested prospect's name and address, and the date, time and nature of the response. At this point the prospect has been defined and established as a not interested prospect. The not interested prospect is then asked to state reasons for being not interest (if willing) and is permitted to the exit the system.

The collection of additional data is optionally utilized for all not interest prospect respondents. It is established uniquely for each organization and responses are coded for ease of response, data storage and use in analysis and possible selection. Information entered is stored in the additional data database 5-A. However, individual organizations may choose to create a separate, from the interested prospect and very interested prospect additional database 5-A, another database for not interested prospect additional data. The additional data collected from not interested prospect respondents serves at least two purposes: 1) to ascertain from a respondent a reason for having “no interest” in the offer and 2) to offer limited category, seasonal or special offer options that might entice the respondent to show a minimum level or form of interest.

Returning the initiation of the not interested prospect response, if the respondent does not enter a UNOC number, or if the entered UNOC number is invalid, the system attempt identify the prospect/customer and determine whether the prospect/customer does in fact desire to participate in the interested prospect offer. If the prospect desires to participate in the interest prospect offer and a UNOC can be located, the prospect is transfer to subroutine C-2 for further processing. If, however, the prospect does not wish to further proceed, he/she is directed to another location or permitted to leave the system.

A similar processing system is employed for interested prospects and very interested prospects (see subroutine C-2). Specifically, and with reference to FIG. 3, 3a, the responding prospect enters the web site, or automated telephone system, of the organization. That is, a prospect who elects to respond to the interested prospect offer will do so through the Internet or automated response telephone answering system. In all cases, the use of the UNOC will be prominently displayed with the offer. Usually the UNOC number will be displayed as a bonus or “valuable coupon” number, along with a unique web page address and toll free telephone number which is linked to the interested prospect entry and very interested prospect upsell/additional data processing system. Upon entry of the UNOC number, the system processes the interested prospect or very interested prospect in the following manner.

As with the not interested prospect processing system, the digital check logic is compared to the check digit of the entered UNOC number to insure accurate entry by the prospect. If this process detects an error, the prospect is instructed to verify the UNOC number from the offer and re-enter the correct number.

After the UNOC number is verified, the UNOC database 3 is accessed to ascertain the prospects name, address, source code and any other information (special offer) associated with that UNOC number. The UNOC database 3 is update to indicate the occurrence of a response, including, the date and time of the response, method of the response and other data relating to the response (name and address). The new interested prospect information is set up on the interested prospect database 5 including the interested prospect's name and address and the date, time and nature of the response. At this point, the prospect has been defined and established as an interested prospect.

Assuming the additional data option is activate, immediately following the interested prospect processing additional data is requested from the interested prospect respondent. That is, the prospect is prompted to enter additional data stored by the system. The data and description are tailored to each organization and or range of UNOC numbers. This information is a coded response, the codes being established to identify each possible and valid response. The entered additional information is stored in the additional data database 5-A, which is keyed by tie to the UNOC number and can be referenced by any process including the prospect preparation process (see subroutine B shown in FIG. 4), the creation of interest prospects and very interest prospect offers D as well as any other promotional, selection or personalization or targeting process. Organizations may choose to bypass the offering of the additional data option, or alternatively, offer it in conjunction (immediately after) with acceptance of the very interested prospect upsell offer.

The next step in the interested prospect processing is the upsell of to very interest prospect status. The step is performed whether or not the additional data option is employed. Whereas the initial interested prospect offer has no charge to the prospect, the very interested prospect offer has usually a small charge to the interested prospect. Responders who have accepted the very interested prospect upsell have indicated a higher level of interest and, therefore, receive more, including all the things that they may receive with their interested prospect status. The very interested prospect enrollment process consists of moving the interested prospect data from the interested prospect database 5 to the very interested prospect database 6, and the data on the UNOC database 3 is accordingly update. Since the acceptance of the very interested prospect offer involves a payment on the part of the prospect, the pricing billing process is utilized to bill the prospect.

At the conclusion of the interested prospect, additional data and very interested prospect processing, the respondent is offered a product upsell or special offer. This is designed to turn him into a true primary offer respondent. The selling process differs for Internet interested prospect responders, who may go directly to a special offer on the Internet sell page. An automated telephone or inbound telemarketing center will offer such upsells or special offers in a telephone-based system.

In all of the interested prospect, very interested prospect, additional data and not interested prospect processing, only the minimum necessary activity occurs that will enable the basic response to be processed before attempting to gather more information from or sell anything (VIP or product/service) to the responder. In addition, during those additional steps, the responder is able to end the session easily and painlessly, without any loss of information so entered.

With reference to FIG. 1, subroutine D for the creation of promotions is outlined. Specifically, the process describes the creation of promotions to interested prospects and very interested prospects. The prospects responding to the IPICS offers on prospect promotions have identified themselves as interested prospect with a high propensity to purchase. While a significant portion of the success of the IPICS process is based on the ability to identify these individuals, of equal importance is the organizations ability to convert these individuals to primary respondents, i.e. customers. Therefore, independent offers, generally targeted with reference to any and all incentives associated with their status as an interested prospect or very interest prospect are selected on basis independent from and generally much more frequently than standard prospects. In these offers the existence and presence of the original UNOC number is highlighted and can be promoted as an “electronic coupon”, constantly reminding the interested prospect of the present terms and sense of urgency (expiration date) of that offer.

Based on parameter selection controls in MMSCI 1, the interested prospect and very interested prospect offerings creation process D, and possibly data on the additional data database 5-A, interested prospect database 5 and very interested prospect database 6, are selected for specific promotions. The promotions are prepared 11 and sent, by indicated channel mail, outbound telemarketing, fax, or e-mail, to the targeted interested prospect and very interested prospect 10.

Upon the creation of the promotion, a new UNOC number is created and a new individual associated data record is established on the UNOC database 3. These numbers are utilized to identify and control those promotions only. They also contain, in their individual data records, the identifying number (original prospect UNOC code), which is also the IPICS (interested prospect, very interested prospect, not interest prospect, and additional data databases, 5, 6, 4, 5-A) individual control number utilized to consolidate all activity surrounding that IPICS responding prospect.

In addition to the specific process outlined here, any communication with prospects can include logic to recognize interested prospects, very interested prospects and not interested prospects. This can be based on identification of the UNOC Control number, match code building logic from name and address, or e-mail address.

As those skilled in the art will certainly appreciate, once the present system is in full operation, information gathered from responses to the various offers proposed in accordance with the present system must be process to provide useful information. With this in mind, and with reference to subroutine B shown FIG. 4, the present system applies a specific prospect preparation process, which involves the preparation of data records, the assignment of the UNOC, the addition of the individual prospect data to the UNOC database 3 and the creation of the creation of the prospect offer D.

The initial steps involving the source of the prospects' name and address, as well as the selection process, remain fundamentally similar to those employed in prior art marketing techniques. That is, identified prospect data records are identified and processed (commonly referred to as “merge-purge”). This “merge-purge” matches duplicates, formats names and addresses, and may apply other information processing and promotional scoring techniques.

During the prospect preparation processing, incoming prospect records are matched with previous interested prospect, very interested prospect and not interested prospect data records. These are the databases created based upon the interested prospect, very interest prospect and not interested prospect responses gathered through the various offers proposed in accordance with the present invention. Matching of these records is accomplished by the match code logic utilized by the organization gathering the information.

The prospect records that match individual customer records on the interested prospect and very interest prospect databases 5, 6 are eliminated from the prospect mailing. Notations relating to the (re) occurrence of the individual prospect are made on the appropriate interested prospect and/or very interest prospect records. These notations contain the data of the processing and source code of the prospect data record.

The processing of those prospects which match data records on the not interested prospect database 4 is generally identical to the processing of data records in the interested prospect and very interested prospect databases 5, 6. However, the present system provides for an option permitting these prospects to be selectively solicited for offers. This information is contained in the Management Marketing Select and Control Information (MMSC1) 1 maintained by the organizations marketing management.

In accordance with the prospect preparation processing, each prospect being made an offer is assigned a UNOC number, a UNOC database 3 is created and the UNOC number is attached to the data records which are to be used for the addressing and the other preparation of the mailed catalogs, letters, coupons or offers 8. Any additional targeting or offer information is also attached to this data record. The implementation of the UNOC number can also be an accuracy and cost reduction method for entering customer and source information for conventional order entry methods of entering the utilized information.

Once the individual offers are prepared, they are sent (or mailed) to individual prospects 9. These offerings contain, in addition to the original primary offer, the UNOC number and the interested prospect offer. While the interested prospect offer is part of the overall offer (catalog), the UNOC number is individualized as part of the addressing scheme by the same means as is the name and address.

More specifically, and with further reference to FIG. 4, prospect processing, UNOC number assignment and database creation are described in detail. Normal prospect processing is first performed and the system determines whether specific prospect records match those of existing customer records. If a prospect record matches an existing customer record, the match is noted in the master record and the prospect is eliminated from the offering being generated.

If, however, the prospect record does not match an existing customer record, the system determines whether the prospect record matches an interested prospect record or a very interested prospect record. If a match is found, the system notes the occurrence of a match in the original UNOC record and selects instructions for eliminating the existing IP/VIP. The system then either eliminates the existing IP/VIP or notes the original UNOC record and updates the administrative statistics.

If the prospect does not match an existing interested prospect or very interested prospect, or if a match is found as discussed above and the system decides to eliminate the existing IP/VIP, the system determines whether the prospect record matches that of a not interested prospect. If the prospect record does match that of an existing not interested prospect, the system next checks to see whether the select instructions and/or not interested prospect data indicate that this not interested prospect should not be promoted. Assuming the select instructions and not interested prospect data indicate that promotions should not be issued, the matching occurrence is noted and the not interested prospect database 4 is updated. If, however, the select instructions and/or not interested prospect data indicates that a promotion may proceed, the system next asks whether the conditions of the particular offer meet the acceptable offer criteria for the matching individual not interested prospect record. If they do not match the conditions, the matching occurrence is noted, the not interested prospect database 4 is updated and no offer is sent out.

The prospect record is then further processed if it does not match an existing not interested prospect or the not interested prospect meets criteria for a designated offer such as that at issue. Specifically, the system next determines whether the prospect record matches a record in the prospect database (if such a database is being maintained by the organization). If the system found that a match does exist, a determination is made as to whether previous prospect scoring data indicates that the present offer should be eliminated. If the prospect scoring indicates that the present matching prospect record does not warrant an offer being made, the prospect database is noted accordingly and the administrative statistics are updated.

If, however, the prospect scoring dictates that an offer should be sent, or if no match is found with the prospect records maintained in the prospect record database, the system verifies that the prospect record matches certain defined instructions, for example, relating to zip code, sex, etc. If a match is found, the system verifies that the match eliminates the prospect record from the promotion being processed and then creates a no offer record in the UNOC database 3.

If however, the matching instructions do not eliminate the prospect record, or the prospect record includes no negative matches, the prospect record is assigned a new UNOC number and a new original UNOC data record is created. The offer record is then prepared based upon select instructions (content, selection, communication and media) and the UNOC number and copy format are attached to the prospect information (name, address, and/or email address). The statistical counts, reporting and control data are updated and the data is sent to an appropriate media communicator (catalog, mail, e-mail, web page, telemarketers, fax, handheld device).

While the IPICS process described above is directed primarily at the identification of interested prospects, it may also be applied to selected elements of an organization's existing customer list for future promotions. Most organizations have a selection, scoring or other method for determining which customers are to be promoted. A significant portion of previous purchasers (hence customer list) is comprised of past purchasers who have not made a recent purchase (recency), have not made a large purchase, or have not purchased more than a few times (frequency). A combination of these factors, as well as others, is ultimately utilized to eliminate these previous customers from one or all future promotions. In the same manner as the IPICS process is utilized to identify interested prospects, it may be utilized to further segment the organization's customers list. This will identify “Interested customers” from within the customers list, especially those who might be approaching inactive and/or non promoted status, to further identify which of the impending inactive customers are still worthy of additional marketing efforts.

While the preferred embodiments have been shown and described, it will be understood that there is no intent to limit the invention by such disclosure, but rather, is intended to cover all modifications and alternate constructions falling within the spirit and scope of the invention as defined in the appended claims.

### GLOSSARY OF TERMS

Primary Offer

This is the main offer of the promotion. It generally is a promotion (mailing, catalog or Internet offer) containing products or services to be offered.

Secondary or IPICS Offer

This is the additional prominently displayed, that contains the information describing the IPICS Interested Prospect (IP) and Not Interested Prospect (NIP) easy to respond to offers.

Uniquely Numbered Offer Control (UNOC)

This is a unique number assigned to each individual promotion used to identify and match respondents to IPICS offers. It is assigned in the Prospect Preparation Process and is displayed in conjunction with IPICS offers. The UNOC number maybe utilized for other purposes including the processing of primary offers and as an electronic coupon to track and process associated customized offers. The UNOC number is sufficiently large to avoid its duplication even with heavy promotion activity over a number of years. This number contains a check digit, utilized to insure accuracy of the numerical entry of responders and others. There are two kinds of UNOC Number

Those associated with prospect offerings, which when responded to become the controlling number for individual IP's, VIP's, and NIP's. All subsequent promotional activity to IP's, VIP's and possibly, NIP's, while containing its own new UNOC number, will also contain on the UNOC database a reference to the original UNOC number. This is utilized to allow update all activity related to the original number. In essence, once a prospect has responded to a prospect promotion, the UNOC number of that promotion becomes a pseudo customer number within the IPICS (IP′, VIP, NIP, and Addition Data) databases.

Those associated with IP, VIP and possibly NIP promotions. These numbers are utilized to identify and control those promotions, and they also contain in their individual data records the identifying number (original prospect UNOC code) which is utilized to consolidate all activity surrounding that IPICS responding prospect.

Interested Prospect (IP)

This is a prospect who, by taking action and responding to an IP offer, has indicated an interest in receiving more offerings, taking advantage of any offers or associated benefits available as a result of this action.

Interested Prospect (IP) Offer

This is the secondary (IPICS) offer, in addition to the primary and traditional product, service or enrollment offer, which has been added to the prospect offer. It is a no-commitment easy-to-use, no cost offer. Offers include but are not limited to, special or larger promotions, future benefits on future orders, guaranteed pricing, discounts, free or free trial club membership. IP benefits are generally included automatically for respondents to the primary offer.

Very Interested Prospect (VIP)

This is a respondent to an IP offer, who (only) after responding to and being processed by the IP process, is offered and accepts the additional VIP offer.

Very Interested Prospect (VIP) Offer

This is an additional upsell to, or requested action by, the just processed IP. This may consist of an option, upsell to a higher, and possibly fee-based, level, supplying additional data, or a product offer(s).

Not Very Interested Prospects (NIP)

These are prospects who have responded to and been processed to a NIP offer.

Not Interested Prospect (NIP) Offer

These are optional secondary (IPICS) offers that may be included in the prospect offerings of primary products and IP offerings. The NIP offer generally contains an offer to eliminate, reduce, or select targeted offers only.

Additional Data

As part of both the IP process and the NIP process, the prospects can (optionall) be asked for and provide additional information (data) which can be stored on the IP or NIP database. In the case of IP this information is utilized to obtain additional product or service information, including interests, size or color, preferred offer delivery, seasonality and media (mail, e-mail, etc.). In the case of NIP data, the information is used to determine reason for no interest including, death, financial, general, or product category, and to “save” prospects by offering highly targeted or very infrequent offerings.

1. An interested prospect identification and control process, comprising the following steps:
providing a primary offer to a group of prospects;
identifying the prospective buyers as customers and non-responding prospects based upon the primary offer;
providing a secondary offer to the prospects;
identifying those non-responding prospects as responding prospects when they respond to the secondary offer; and
applying gathered information in enhancing future offerings.

2. The interested prospect identification and control process according to claim 1, wherein the primary offer and the secondary offer are simultaneously provided to prospects.

3. The interested prospect identification and control process according to claim 1, wherein the responding prospects are further classified as interested prospects and very interested prospects.

4. The interested prospect identification and control process according to claim 3, wherein an upsell offer is made to prospects responding to the secondary offer and those prospects responding to the upsell offer are classified as very interested prospects.

5. The interested prospect identification and control process according to claim 1, wherein the responding prospects are further classified as interested prospects, very interested prospects and not interested prospects.

6. The interested prospect identification and control process according to claim 5, wherein an upsell offer is made to prospects responding to the secondary offer and those prospects responding to the upsell offer are classified as very interested prospects.

7. The interested prospect identification and control process according to claim 5, wherein the secondary offer includes a not interested prospect element and those prospects responding to the not interested prospect element are classified as very interested prospects.

8. The interested prospect identification and control process according to claim 7, further including the step of providing not interested prospects with an opportunity to remove their name from future offers.

9. The interested prospect identification and control process according to claim 5, further including the step of providing not interested prospects with an opportunity to remove their name from future offers.

10. The interested prospect identification and control process according to claim 1, further including the step of offering responding prospects an upsell, and classifying those responding prospects who accept the upsell as very interest prospects and those who refuse the upsell as interested prospects.

11. The interested prospect identification and control process according to claim 1, further including appending a uniquely numbered offer control number to each secondary offer.

12. The interested prospect identification and control process according to claim 1, wherein the secondary offer is chosen from the group consisting of offers to receive future offers; enrollment in a free club; receipt of a discount/benefit on a future order, receipt of discounts for future needed items for which there is not an immediate need; a free premium; a free trial; a sweepstakes type of offer; discounted shipping and handling; airline miles; free software; discounts on specific products; informational products; avoidance of an expiration date and combinations of one or more of the above.

13. A system for identifying interested prospects in a directing marketing process, comprising:
an offer database in which offers being utilized by an organization are stored, the offers including primary offers directed to a promotion containing products or services to be offered and secondary offers directed to eliciting a response from those prospects not wishing to respond to the primary offer.
a uniquely numbered offer control database in which control numbers associated with each offer are stored;
an interested prospects database in which data relating to prospects who have responded to the secondary offer are stored; and
means for processing information relating to the primary and secondary offers.

14. The system according to claim 13, further including a very interested prospects database in which data relating to those prospects who respond to the secondary offer and an upsell is stored.

15. The system according to claim 13, further including a not interested prospects database in which data relating to those prospects who respond to a not interested prospects element of the secondary offer is stored.

16. The system according to claim 13, wherein the secondary offer is chosen from the group consisting of offers to receive future offers; enrollment in a free club; receipt of a discount/benefit on a future order; receipt of discounts for future needed items for which there is not an immediate need; a free premium; a free trial; a sweepstakes type of offer, discounted shipping and handling; airline miles; free software; discounts on specific products; informational products; avoidance of an expiration date and combinations of one or more of the above.

17. The system according to claim 13, further including an additional data database.
